(19) United States
(12) Patent Application Publication
(10) Pub. No.: US 2010/0125838 A1
(43) Pub. Date: May 20, 2010

(54) Method and Apparatus for Optimizing a Program

(75) Inventors: Kimmo Kalervo Kuusilinna, Emeryville, CA (US); Jussi Pekka Olavi Ruutu, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/273,869

(22) Filed: Nov. 19, 2008

(51) Int. Cl. G06F 9/44

(52) U.S. Cl. 717/158

(57) ABSTRACT

In accordance with an example embodiment of the present invention, an apparatus comprising a processor configured to receive from a first device, a first profile information related to a first part of a program, receive from a second device, a second profile information related to a second part of the program, perform optimization on the program based at least in part on the first profile information and the second profile information, generate a first program information associated with the optimized program comprising a first directive for collecting profile information relating to a first part of the optimized program, generate a second program information associated with the optimized program comprising a second directive for collecting profile information relating to a second part of the optimized program, send the first program information to the first device, and send the second program information to the second device is disclosed.

### TECHNICAL FIELD

The present application relates generally to optimizing a program.

### BACKGROUND

There has been a recent surge in the use of electronic devices. Many electronic device execute one or more programs. For example, an electronic device may execute firmware, a device driver, a codec, a game, a web browser, and/or the like.

The growth of electronic devices has been accompanied by a surge in programs that use communication networks to send and receive information. For example, a program may use a network to send and/or retrieve an image, a video, a message, text, a program, and/or the like.

### SUMMARY

Various aspects of examples of the invention are set out in the claims.

According to a first aspect of the present invention, an apparatus comprising a processor configured to receive from a first device, a first profile information related to a first part that is less than the whole of a program, receive from a second device, a second profile information related to a second part that is less than the whole of the program, perform optimization on the program based at least in part on the first profile information and the second profile information, generate a first program information associated with the optimized program comprising a first directive for collecting profile information relating to a first part that is less than the whole of the optimized program, generate a second program information associated with the optimized program comprising a second directive for collecting profile information relating to a second part that is less than the whole of the optimized program, send the first program information to the first device, and send the second program information to the second device is disclosed.

According to a second aspect of the present invention, an apparatus, comprising a processor configured to receive a program information associated with a program comprising a directive for collecting profile information relating to a part that is less than the whole of the program, execute the program, collect profile information relating to the program based at least in part on the directive, and send the collected profile information to a server is disclosed.

According to a third aspect of the present invention, a method, comprising receiving from a first device a first profile information related to a first part that is less than the whole of a program, receiving from a second device a second profile information related to a second part that is less than the whole of the program, performing optimization on the program based at least in part on the first profile information and the second profile information, generating a first program information associated with the optimized program comprising a directive for collecting profile information relating to a first part that is less than the whole of the optimized program, generating a second program information associated with the optimized program comprising a directive for collecting profile information relating to a second part that is less than the whole of the optimized program, sending the first program information to the first device, and sending the second program information to the second device is disclosed.

According to a fourth aspect of the present invention, a computer program product comprising a computer-readable medium bearing computer program code embodied therein for use with a computer, the computer program code comprising code for receiving from a first device a first profile information related to a first part that is less than the whole of a program, code for receiving from a second device a second profile information related to a second part that is less than the whole of the program, code for performing optimization on the program based at least in part on the first profile information and the second profile information, code for generating a first program information associated with the optimized program comprising a directive for collecting profile information relating to a first part that is less than the whole of the optimized program, code for generating a second program information associated with the optimized program comprising a directive for collecting profile information relating to a second part that is less than the whole of the optimized program, code for sending the first program information to the first device, and code for sending the second program information to the second device is disclosed.

According to a fifth aspect of the present invention, a computer-readable medium encoded with instructions that, when executed by a computer, perform receiving from a first device a first profile information related to a first part that is less than the whole of a program, receiving from a second device a second profile information related to a second part that is less than the whole of the program, performing optimization on the program based at least in part on the first profile information and the second profile information, generating a first program information associated with the optimized program comprising a directive for collecting profile information relating to a first part that is less than the whole of the optimized program, generating a second program information associated with the optimized program comprising a directive for collecting profile information relating to a second part that is less than the whole of the optimized program, sending the first program information to the first device, and sending the second program information to the second device is disclosed.

According to a sixth aspect of the present invention, a method, comprising receiving a program information associated with a program comprising a directive for collecting profile information relating to a part that is less than the whole of the program, executing the program, collecting profile information relating to the program based at least in part on the directive, and sending the collected profile information to a server is disclosed.

According to a seventh aspect of the present invention, a computer program product comprising a computer-readable medium bearing computer program code embodied therein for use with a computer, the computer program code comprising code for receiving a program information associated with a program comprising a directive for collecting profile information relating to a part that is less than the whole of the program, code for executing the program, code for collecting profile information relating to the program based at least in part on the directive, and code for sending the collected profile information to a server is disclosed.

According to an eighth aspect of the present invention, a computer-readable medium encoded with instructions that, when executed by a computer, perform receiving a program information associated with a program comprising a directive for collecting profile information relating to a part that is less than the whole of the program, executing the program, collecting profile information relating to the program based at least in part on the directive, and sending the collected profile information to a server is disclosed.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram showing a system according to an example embodiment of the invention;

FIG. 2 is a flow diagram showing a method for collecting profile information according to an example embodiment of the invention;

FIG. 3 is a flow diagram showing another method for collecting profile information according to an example embodiment of the invention;

FIG. 4 is a flow diagram showing a method for optimizing a program according to an example embodiment of the invention;

FIG. 5 is a flow diagram showing another method for optimizing a program according to an example embodiment of the invention; and

FIG. 6 is a block diagram showing an electronic device according to an example embodiment of the invention.

### DETAILED DESCRIPTION OF THE DRAWINGS

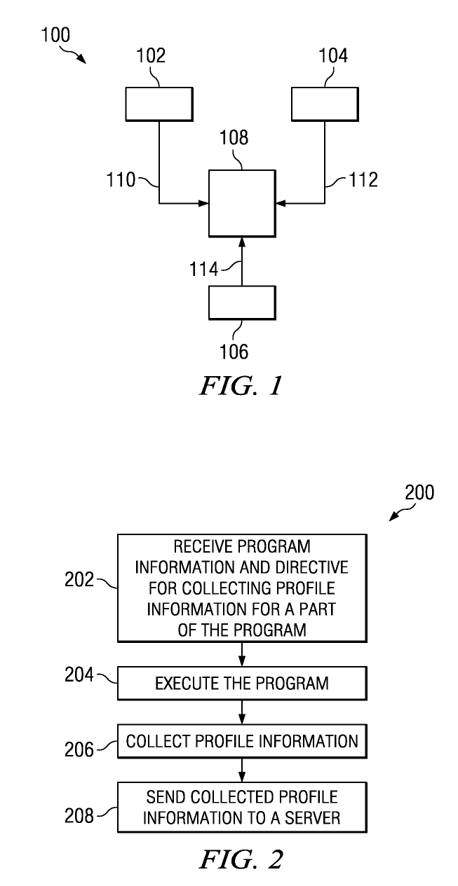

An example embodiment of the present invention and its potential advantages are best understood by referring to FIGS. 1 through 6 of the drawings.

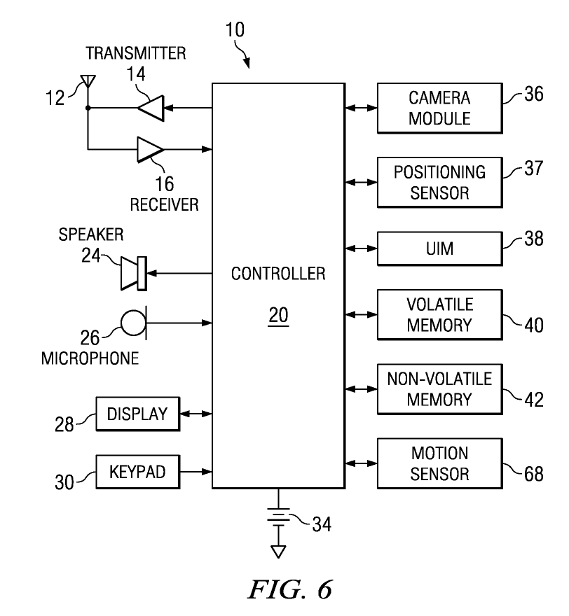

A program for an electronic device, for example electronic device 10 of FIG. 6, may be optimized. Optimization may relate to generating the program and/or determining settings associated with generating the program so that a desirable operation criteria may be better satisfied. Optimization may comprise balancing parallel thread operation with operation overhead associated with parallel threads, balancing code size with execution speed, selecting an implementation of a mathematical function, ordering information in memory, ordering information in processing, balancing control flow implementation, a loop optimization technique such as unrolling, balancing compiler options, eliminating a performance bottleneck, and/or the like. In an example embodiment, optimization balances thread performance and resource utilization. For example, a non-optimized program running on a multiprocessor device may allow one or more processors to be underutilized. In such an example, optimizing the program to allow more threads to operate in parallel may result in higher processor utilization. In another example, the same non-optimized program running on a single processor device with limited memory may be utilizing a large amount of memory for parallel thread operation. In such an example, optimizing the program to allow fewer threads to operate in parallel may result in reduced memory utilization.

Optimization may be performed when a program is generated, for example by a compiler, a linker, and/or the like. For example, there may be one or more compile options associated with optimization. In such an example, the compile option may determine the way the executable code for the program is generated.

Optimization may be performed after a program is generated, for example by using one or more configuration settings. For example, there may be one or more configuration settings for an operating system to use when executing a program. In such an example, the configuration setting may control one or more aspects of the execution of the program, such as thread allocation.

Information used for optimization may be predetermined and/or post-determined. For example, optimization information may be predetermined by a programmer, operator, and/or the like, when the program is developed. In another example, optimization information may be post-determined by collecting profile information during the execution of the program. Profile information may relate to one or more aspects of a program's execution on a device. For example, profile information may comprise information relating to thread utilization, processor utilization, memory utilization, execution path, busy-wait periods for unavailable information, communication pattern between threads and/or code modules, variable values, number and/or interval of function calls, number and/or interval of instruction fetches, number and/or interval of data accesses, device information, event information, error information, and or the like.

The collection of profile information may be determined by a directive. The directive may relate to a program instruction, a setting, configuration information, and/or the like that may be utilized to collect profile information. For example, a directive may relate to one or more program instruction for collecting profile information. In such an example, a directive may relate to program instructions for storing information relating to thread performance. For example, a directive may relate to collecting information relating to the number of times a function is called. In another example, a directive may relate to collecting information relating to wait-busy periods associated with one or more data structures.

In an example embodiment, profile information is collected during the execution of a program and utilized for optimizing the program. For example, a device may have a directive to collect profile information while executing the program. After collecting profile information, the profile information from the device may be utilized to optimize the program.

In another example embodiment, profile information is collected during the execution of a previously optimized program and utilized to further optimize the previously optimized program. For example, a device may have a directive to collect profile information while executing a previously optimized program. After collecting profile information, the profile information may be utilized to further optimize the previously optimized program.

In still another example embodiment, a non-optimized program comprises two parallel threads. Profile information may indicate that the threads rarely wait for information from another thread and that thread overhead is low. The program may be optimized to use four concurrent threads.

In yet another example embodiment, a previously optimized program may have been experimentally optimized, for example by modifying a compiler option associated with execution speed and memory behavior. Profile information may indicate that the previously optimized program performed less optimally than the non-optimized program. The previously optimized program may be optimized to be more similar to the non-optimized program.

A server may be utilized to optimize a program using profile information collected by one or more device running the program. For example, the server may receive profile information relating to a program from one or more device and optimize the program using the profile information.

In an example embodiment, profile information may be obtained in observance of user privacy. For example, profile information may be sent without accompanying user information. In another example, a user ID, without any other user information may accompany profile information. In still another example, user information may accompany profile information based at least in part on a privacy setting. In such an example, the user may control the privacy setting. In yet another example, communication may be encrypted.

FIG. 1 is a block diagram showing a system 100 according to an example embodiment of the invention. System 100 may comprise a server 108, and one or more devices, for example device 102, device 104, and device 106. In an example embodiment, server 108 and devices 102, 104, and 106 may be coupled to each other directly and/or indirectly. Server 108 may comprise a computer program that may optimize a program. Devices 102, 104, and 106 may execute the program and collect profile information.

In an example embodiment, server 108 receives profile information related to a program from one or more devices, for example device 102. Server 108 may utilize the profile information to optimize the program. Server 108 may send the optimized program to one or more devices, for example device 104.

In another example embodiment, server 108 may request profile information from one or more devices, for example device 106. After receiving at least part of the profile information, server 108 may utilize the profile information to optimize the program. Server 108 may send the optimized program to one or more devices, for example device 102.

In still another example embodiment, server 108 receives profile information related to a program from one or more devices, for example device 102. Server 108 may aggregate received profile information. For example, server 108 may statistically merge similar profile information, for example by averaging, may merge received profile information into a single profile information, and/or the like. Server 108 may utilize the aggregated profile information to optimize the program. Server 108 may send the optimized program to one or more devices, for example device 104.

Profile information directives may vary across devices executing a program. For example, device 102 and device 104 may collect profile information according to different directives. In such an example, profile information from device 104 may be utilized with profile information from device 106 to optimize the program.

In an example embodiment, devices 102, 104, and 106 executing a program may have limited capabilities with respect to memory, communication, performance, and/or the like. Different directives related to collecting profile information may be given to devices 102, 104, and 106 such that each device has a directive that will not overburden the devices. Server 108 may optimize the program based at least in part on profile information received from devices 102, 104, and 106. Server 108 may send the optimized program with a directive to device 102, with a different directive to device 104, and with still a different directive to device 106.

It should be understood that server 108 may comprise more than one apparatus. For example, server 108 may comprise a communication apparatus, a database, a computational apparatus, a compiler, an authentication server, and/or the like. A device, for example device 102, may be used to interact with server 108. For example, a device, such as device 102, may be an electronic device, for example electronic device 10 of FIG. 6, a computer, and/or the like.

Link 110 may provide communication between device 102 and server 108. Link 112 may provide communication between device 104 and server 108. Link 114 may provide communication between device 106 and server 108. A link, for example link 110, may comprise internet communication, wireless communication, cellular communication, and/or the like. Link communication may comprise messaging, remote procedure calls, and/or the like. A link may utilize a receiver, for example receiver 16 of FIG. 6, a transmitter, for example transmitter 14 of FIG. 6, and/or the like.

FIG. 2 is a flow diagram showing a method 200 for collecting profile information according to an example embodiment of the invention. An apparatus, for example electronic device 10 of FIG. 6, may be configured to perform method 200.

At block 202, program information and a directive for collecting profile information for a part of the program are received. The program information may comprise one or more program instructions, one or more settings, configuration information, and/or the like. For example, the program information may comprise executable instructions for a program. In another example, the program information may comprise a program in its entirety. In still another example, the program information may comprise executable instructions and configuration information for a program. The program information and directive may be received from a server, for example server 108 of FIG. 1. The program information and directive may be received using a link, for example link 110 of FIG. 1. The program information and directive may be received together or separately.

At block 204, the program is executed. Execution of the program may be started after the program information is received at block 202, when an input associated with starting the program is received, and/or the like.

At block 206, profile information is collected in relation to the execution of the program. The collection of the profile information may comprise storing information in memory, for example, volatile memory 40 of FIG. 6, non-volatile memory 42 of FIG. 6, and/or the like. The collection of the profile information may comprise storing known information related to the execution of the program, querying for information related to the execution of the program, and/or the like. For example, collection of the profile information may comprise querying operational information from an operating system during the execution of the program, such as available memory, processor sleep information, and/or the like. In another example, collection of the profile information may comprise storing information utilized by the program, such as a data structure, a setting, an object, and/or the like.

At block 208, the collected profile information is sent. The profile information may be sent to a server, for example server 108 of FIG. 1. The profile information may be sent using a link, for example link 110 of FIG. 1. The profile information may be sent based on a schedule, a constraint, a request, and/or the like. For example, the profile information may be sent periodically. In another example, the profile information may be sent when a quantity of profile information has been collected. In another example, profile information may be sent in response to a request for the profile information is received form a server, for example server 108 of FIG. 1.

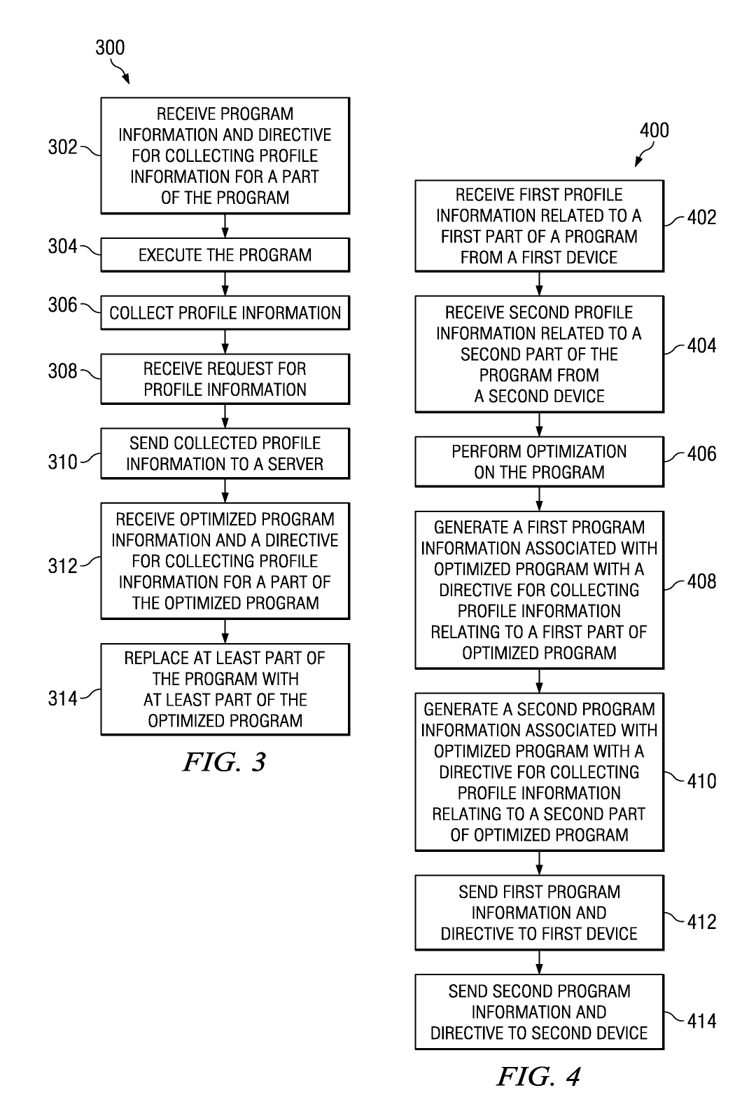

FIG. 3 is a flow diagram showing another method 300 for collecting profile information according to an example embodiment of the invention. An apparatus, for example electronic device 10 of FIG. 6, may be configured to perform method 300.

At block 302, program information and a directive for collecting profile information for a part of the program is received. The program information and the directive for collecting profile information for a part of the program may be received similarly as described with reference to block 202 of FIG. 2.

At block 304, the program is executed. The program execution may be similar as described with reference to block 204 of FIG. 2.

At block 306, profile information is collected. The profile information collection may be similar as described with reference to block 206 of FIG. 2.

At block 308, a request for the profile information is received. The request for the profile information may be received from a server, for example server 108 of FIG. 1. The request for the profile information may be received using a link, for example link 110 of FIG. 1.

At block 310, the collected profile information is sent. The profile information sending may be similar as described with reference to block 208 of FIG. 2.

At block 312, optimized program information and a directive for collecting profile information for a part of the optimized program is received. The optimized program information may comprise one or more program instructions, one or more settings, configuration information, and/or the like. For example, the optimized program information may comprise executable instructions for a program. In another example, the optimized program information may comprise a program in its entirety. In still another example, the optimized program information may comprise executable instructions and configuration information for a program. The optimized program information and directive may be received from a server, for example server 108 of FIG. 1. The optimized program information and directive may be received using a link, for example link 110 of FIG. 1.

At block 314, at least part of the program is replaced with at least part of the optimized program information. For example, the optimized program information may relate to a part of a program, such as a library, a module, and/or the like. In such an example, the part of the program will be replaced with optimized program information. In another example, the optimized program information may comprise an optimized program in its entirety. In such an example, the optimized program may replace the program.

FIG. 4 is a flow diagram showing a method 400 for optimizing a program according to an example embodiment of the invention. An apparatus, for example electronic device 10 of FIG. 6, may be configured to perform method 400.

At block 402, a first profile information related to a first part of a program is received from a first device, for example device 102 of FIG. 1. The profile information may be received using a link, for example link 110 of FIG. 1.

At block 404, a second profile information related to a second part of the program is received from a second device, for example device 104 of FIG. 1. The profile information may be received using a link, for example link 112 of FIG. 1.

At block 406, optimization is performed on the program. The optimization may be based at least in part on the first profile information and the second profile information. Optimization may relate to generating the program and/or determining settings associated with generating the program so that a desirable operation criteria may be better satisfied. Optimization may comprise balancing parallel thread operation with operation overhead associated with parallel threads, balancing code size with execution speed, selecting an implementation of a mathematical function, ordering information in memory, ordering information in processing, balancing control flow implementation, a loop optimization technique such as unrolling, balancing compiler options, eliminating a performance bottleneck, and/or the like.

At block 408, a first program information associated with optimized program with a directive for collecting profile information relating to a first part of the optimized program is generated. The first part of the program may be less than the whole of the program. For example, the first part of the program may relate to one or more module of the program.

The directive may be predetermined and/or dynamically determined. For example, the directive may be similar to the directive associated with the previous profile information. In another example, the directive may be randomly generated. In still another example, the directive may be based, at least in part, on information related to the first device such as device performance, memory, communication, and/or the like. In such an example, the directive may be determined to avoid overburdening the device.

At block 410, a second program information associated with optimized program with a directive for collecting profile information relating to a second part of the optimized program is generated. The second part of the program may be less than the whole of the program. For example, the second part of the program may relate to one or more module of the program. The second part of the program may differ from the first part of the program information. For example, the first part of the program information may relate to a module, and the second part of the program information may relate to a different module.

The directive may be predetermined and/or dynamically determined. For example, the directive may be similar to the directive associated with the previous profile information. In another example, the directive may be randomly generated. In still another example, the directive may be based, at least in part, on information related to the second device such as device performance, memory, communication, and/or the like. In such an example, the directive may be determined to avoid overburdening the device.

At block 412, the first program information and directive are sent to the first device. The profile information may be sent using a link, for example link 110 of FIG. 1.

At block 414, the second program information and directive are sent to the second device. The profile information may be sent using a link, for example link 112 of FIG. 1.

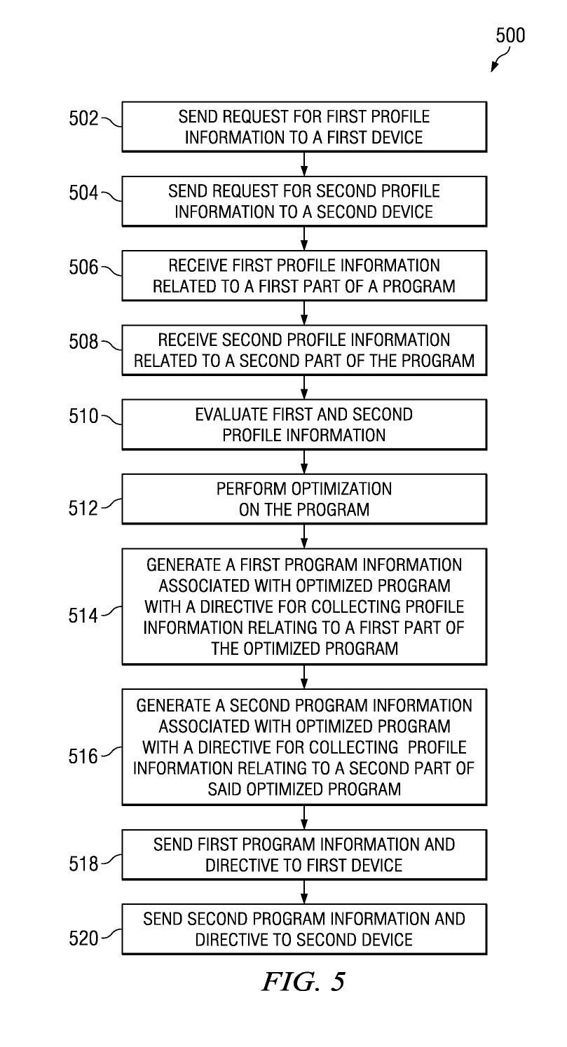

FIG. 5 is a flow diagram showing another method for optimizing a program according to an example embodiment of the invention. An apparatus, for example electronic device 10 of FIG. 6, may be configured to perform method 500.

At block 502, a request for a first profile information is sent to a first device, for example device 102 of FIG. 1. The request may be sent using a link, for example link 110 of FIG. 1. The request may be sent based on a schedule, a command, and/or the like. For example, the profile information may be requested periodically. In another example, the profile information may be requested when a user issues a command to do so.

At block 504, a request for a second profile information is sent to a second device, for example device 102 of FIG. 1. The request may be sent using a link, for example link 110 of FIG. 1. The request may be sent based on a schedule, a command, and/or the like. For example, the profile information may be requested periodically. In another example, the profile information may be requested when a user issues a command to do so.

At block 506, a first profile information related to a first part of a program is received from a first device. The profile information and its receiving may be similar as described with reference to block 402 of FIG. 4.

At block 508, a second profile information related to a second part of the program is received from a second device. The profile information and its receiving may be similar as described with reference to block 404 of FIG. 4.

At block 510, the first profile information and the second profile information are evaluated. The evaluation may comprise merging the profile information, filtering the profile information, and/or the like. For example, the first profile information and the second profile information may be merged to determine optimization related to the first part of the program associated with the first profile information and the second part of the program associated with the second profile information. In another example, at least part of the first profile information and at least part of the second profile information may be statistically combined, for example averaged.

At block 512, optimization is performed on the program. The optimization may be similar as described with reference to block 406 of FIG. 4.

At block 514, a first program information associated with optimized program with a directive for collecting profile information relating to a first part of the optimized program is generated. The generation may be similar as described with reference to block 408 of FIG. 4.

At block 516, a second program information associated with optimized program with a directive for collecting profile information relating to a second part of the optimized program is generated. The generation may be similar as described with reference to block 410 of FIG. 4.

At block 518, the first program information and directive are sent to the first device. The sending may be similar as described with reference to block 412 of FIG. 4.

At block 520, the second program information and directive are sent to the second device. The sending may be similar as described with reference to block 414 of FIG. 4.

FIG. 6 is a block diagram showing an electronic device 10 according to an example embodiment of the invention. It should be understood, however, that a electronic device as illustrated and hereinafter described is merely illustrative of an electronic device that would benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, global positioning system (GPS) devices and other types of electronic systems, may readily employ embodiments of the present invention. Furthermore, devices may readily employ embodiments of the present invention regardless of their intent to provide mobility.

Even though embodiments of the present invention are described in conjunction with mobile communications applications, it should be understood that embodiments of the present invention may be utilized in conjunction with a variety of other applications, both in the mobile communications industries and outside of the mobile communications industries.

The electronic device 10 may comprise an antenna 12 (or multiple antennae) in operable communication with a transmitter 14 and a receiver 16. The electronic device 10 further comprises a controller 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, wireless networking protocols, such as 802.11, short-range wireless protocols, such as Bluetooth, and/or the like.

It is understood that the controller 20 comprises circuitry desirable for implementing audio, video, communication, navigation, logic functions, and or the like. For example, the controller 20 may comprise a digital signal processor device, a microprocessor device, various analog to digital converters, digital to analog converters, and other support circuits. Control and signal processing functions of the electronic device 10 are allocated between these devices according to their respective capabilities. The controller 20 thus may also comprise the functionality to encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional internet browser. The connectivity program may then allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the controller 20. The user input interface, which allows the electronic device 10 to receive data, may comprise any of a number of devices allowing the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display may determine input based on position, motion, speed, contact area, and/or the like. In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the controller 20 in the form of software for creating a digital image file from a captured image. In an example embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The electronic device 10 may comprise one or more user identity modules (UIM) 38. UIM 38 may comprise information stored in memory of electronic device 10, a part of electronic device 10, a device coupled with electronic device 10, and/or the like. UIM 38 may comprise a memory device having a built in processor. UIM 38 may comprise, for example, a subscriber identity module (SIM), a universal integrated circuit card (UICC), a universal subscriber identity module (USIM), a removable user identity module (R-UIM), and/or the like. UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM 38 and disable usage of a second UIM 38. Usage of more than one UIM 38 may comprise concurrent utilization of information related to a first UIM 38 and a second UIM 38.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may additionally or alternatively comprise an EEPROM, flash memory or the like. The memories may store any of a number of pieces of information, and data. The information and data may be used by the electronic device 10 to implement the functions of the electronic device 10. For example, the memories may comprise an identifier, such as an international mobile equipment identification (IMEI) code, which may uniquely identify the electronic device 10.

Although FIG. 6 illustrates an example of an electronic device which may utilize embodiments of the present invention, it should be understood that the electronic device 10 of FIG. 6 is merely an example device that may utilize embodiments of the present invention.

A processing element such as those described may be embodied in various ways. For example, the processing element may be embodied as a processor, a coprocessor, a controller or various other processing means or devices including integrated circuits such as, for example, an ASIC (application specific integrated circuit), FPGA (field programmable gate array), and/or the like.

Without in any way limiting the scope, interpretation, or application of the claims appearing below, it is possible that a technical effect of one or more of the example embodiments disclosed herein may be optimizing a program using profile information gathered form more than one device. Another possible technical effect of one or more of the example embodiments disclosed herein may be collecting profile information without overburdening a device. Another technical effect of one or more of the example embodiments disclosed herein may be obtaining profile information using different collection directives across multiple devices.

Embodiments of the present invention may be implemented in software, hardware, application logic or a combination of software, hardware and application logic. The software, application logic and/or hardware may reside on a device, a part of a server, or a different part of a server. If desired, part of the software, application logic and/or hardware may reside on a device, part of the software, application logic and/or hardware may reside on a part of a server, and part of the software, application logic and/or hardware may reside on different part of a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising a processor configured to:
receive from a first device, a first profile information related to a first part that is less than the whole of a program;
receive from a second device, a second profile information related to a second part that is less than the whole of said program;
optimize on the program based at least in part on said first profile information and said second profile information;
generate a first program information associated with said optimized program comprising a first directive for collecting profile information relating to a first part that is less than the whole of said optimized program;
generate a second program information associated with said optimized program comprising a second directive for collecting profile information relating to a second part that is less than the whole of said optimized program;
send said first program information to said first device; and
send said second program information to said second device.

2. The apparatus of claim 1, wherein said receiver utilizes a wireless network.

3. The apparatus of claim 1, wherein said first profile information comprises thread allocation information.

4. The apparatus of claim 1, wherein said first profile information comprises execution path information.

5. The apparatus of claim 1, wherein said first profile information comprises memory use information.

6. The apparatus of claim 1, wherein said optimization relates to thread allocation.

7. The apparatus of claim 1, wherein said optimization relates to execution path.

8. The apparatus of claim 1, wherein said optimization relates to memory use.

9. The apparatus of claim 1, wherein said optimization comprises determination of a compiler setting.

10. The apparatus of claim 1, wherein said optimization comprises program compilation.

11. The apparatus of claim 1, wherein said generation of said first program information comprises generating executable code.

12. The apparatus of claim 1, wherein said first directive comprises a program instruction.

13. The apparatus of claim 1, wherein said first directive comprises configuration information.

14. The apparatus of claim 1, wherein said transmitter utilizes a wireless network.

15. The apparatus of claim 1, wherein said processor is further configured to evaluate said first profile information and said second profile information, wherein said optimization is based at least in part on said evaluation.

16. The apparatus of claim 1, wherein said processor comprises at least one memory that contains executable instructions that if executed by the processor cause the apparatus to:
receive from a first device, a first profile information related to a first part that is less than the whole of a program;
receive from a second device, a second profile information related to a second part that is less than the whole of said program;
optimize on the program based at least in part on said first profile information and said second profile information;
generate a first program information associated with said optimized program comprising a directive for collecting profile information relating to a first part that is less than the whole of said optimized program;
generate a second program information associated with said optimized program comprising a directive for collecting profile information relating to a second part that is less than the whole of said optimized program;
send said first program information to said first device; and
send said second program information to said second device.

17. An apparatus, comprising a processor configured to:
receive a program information associated with a program comprising a directive for collecting profile information relating to a part that is less than the whole of said program;
execute the program;
collect profile information relating to said program based at least in part on said directive; and
send said collected profile information to a server.

18. The apparatus of claim 17, wherein said processor is further configured to receive a request for said profile information using said receiver.

19. The apparatus of claim 17, wherein said processor is further configured to receive, using said receiver, an optimized program information associated with an optimized program comprising a directive for collection of profile information relating to a part that is less than the whole of said optimized program.

20. The apparatus of claim 17, wherein said processor is further configured to replace at least part of said program with at least part of said optimized program.

21. The apparatus of claim 17, wherein said receiver utilizes a wireless network.

22. The apparatus of claim 17, wherein said transmitter utilizes a wireless network.

23. The apparatus of claim 17, wherein said profile information comprises thread allocation information.

24. The apparatus of claim 17, wherein said profile information comprises execution path information.

25. The apparatus of claim 17, wherein said profile information comprises memory use information.

26. The apparatus of claim 17, wherein said apparatus comprises a mobile terminal

27. The apparatus of claim 17, wherein said processor comprises at least one memory that contains executable instructions that if executed by the processor cause the apparatus to:
receive a program information associated with a program comprising a directive for collecting profile information relating to a part that is less than the whole of said program;
execute the program;
collect profile information relating to said program based at least in part on said directive; and
send said collected profile information to a server.

28. A method, comprising:
receiving from a first device a first profile information related to a first part that is less than the whole of a program;
receiving from a second device a second profile information related to a second part that is less than the whole of said program;
performing optimization on the program based at least in part on said first profile information and said second profile information;
generating a first program information associated with said optimized program comprising a directive for collecting profile information relating to a first part that is less than the whole of said optimized program;
generating a second program information associated with said optimized program comprising a directive for collecting profile information relating to a second part that is less than the whole of said optimized program;
sending said first program information to said first device; and
sending said second program information to said second device.

29. A computer program product comprising a computer-readable medium bearing computer program code embodied therein for use with a computer, the computer program code comprising:
code for receiving from a first device a first profile information related to a first part that is less than the whole of a program;
code for receiving from a second device a second profile information related to a second part that is less than the whole of said program;
code for performing optimization on the program based at least in part on said first profile information and said second profile information;
code for generating a first program information associated with said optimized program comprising a directive for collecting profile information relating to a first part that is less than the whole of said optimized program;
code for generating a second program information associated with said optimized program comprising a directive for collecting profile information relating to a second part that is less than the whole of said optimized program;
code for sending said first program information to said first device; and
code for sending said second program information to said second device.

30. A computer-readable medium encoded with instructions that, when executed by a computer, perform:
receiving from a first device a first profile information related to a first part that is less than the whole of a program;
receiving from a second device a second profile information related to a second part that is less than the whole of said program;
performing optimization on the program based at least in part on said first profile information and said second profile information;
generating a first program information associated with said optimized program comprising a directive for collecting profile information relating to a first part that is less than the whole of said optimized program;
generating a second program information associated with said optimized program comprising a directive for collecting profile information relating to a second part that is less than the whole of said optimized program;
sending said first program information to said first device; and
sending said second program information to said second device.

31. A method, comprising:
receiving a program information associated with a program comprising a directive for collecting profile information relating to a part that is less than the whole of said program;
executing the program;
collecting profile information relating to said program based at least in part on said directive; and
sending said collected profile information to a server.

32. A computer program product comprising a computer-readable medium bearing computer program code embodied therein for use with a computer, the computer program code comprising:
code for receiving a program information associated with a program comprising a directive for collecting profile information relating to a part that is less than the whole of said program;
code for executing the program;
code for collecting profile information relating to said program based at least in part on said directive; and
code for sending said collected profile information to a server.

33. A computer-readable medium encoded with instructions that, when executed by a computer, perform:
receiving a program information associated with a program comprising a directive for collecting profile information relating to a part that is less than the whole of said program;
executing the program;
collecting profile information relating to said program based at least in part on said directive; and
sending said collected profile information to a server.

34-58. (canceled)
